(19) United States
(12) Patent Application Publication
(10) Pub. No.: US 2025/0085716 A1
(43) Pub. Date: Mar. 13, 2025

(54) SYSTEMS AND METHODS FOR IMPROVING AIR QUALITY USING REAL-TIME 3-D GRADIENT SEARCH

(71) Applicant: Varini Kadakia, Saratoga, CA (US)

(72) Inventor: Varini Kadakia, Saratoga, CA (US)

(21) Appl. No.: 18/648,620

(22) Filed: Apr. 29, 2024

Related U.S. Application Data
(60) Provisional application No. 63/581,294, filed on Sep. 8, 2023.

(51) Int. Cl. G05D 1/648; G05D 105/10; G05D 105/80; G05D 107/10; G05D 109/20

(52) U.S. Cl. CPC G05D 1/648; G05D 2105/10; G05D 2105/80; G05D 2107/10; G05D 2109/20

(57) ABSTRACT

An un-manned aerial vehicle (UAV) for use in mitigation air pollution is provided. The UAV may include a filter system that draws in ambient air and passes the ambient air through a particulate filter to clean the air. The UAV may travel to a first location within an area of interest that needs to be cleaned. The UAV may then move to a second location that is a predetermined distance from the first location in x, y, or z directions. The UAV may further determine a first particulate matter measurement at the second location and determine a third location within the area of interest based on the first particulate matter measurement and the first location. The UAV may then determine a second particulate matter measurement at the third location and initiate a filtration process based on the first particulate matter measurement and the second particulate matter measurement.

### CROSS-REFERENCES TO RELATED APPLICATIONS

This application claims priority to U.S. Provisional Patent application No. 63/581,294, filed on Sep. 8, 2023 and titled “Drone-Based System to Reduce Air Pollution Using Inexpensive Materials.” The disclosure of the provisional patent application is incorporated herein in its entirety for all purposes.

### FIELD

This disclosure relates generally to mitigating air pollution. More specifically, embodiments of this disclosure relate to use of an automated unmanned aerial vehicle to reduce outdoor air pollution in a geographic area.

### BACKGROUND

Outdoor air pollution ranks as the fourth leading cause of global mortality, impacting over 91% of the world's population and claiming approximately 4.2 million lives annually. Despite the widespread effects of air pollution, there is a lack of accessible, efficient, and cost effective solutions for pollution mitigation.

### BRIEF DESCRIPTION OF THE DRAWINGS

The detailed description is set forth with reference to the accompanying drawings. In some instances, the use of the same reference numerals may indicate similar or identical items. Various embodiments may utilize elements and/or components other than those illustrated in the drawings, and some elements and/or components may not be present in various embodiments. Throughout this disclosure, depending on the context, singular and plural terminology may be used interchangeably.

FIG. 1 illustrates a block diagram of a pollution mitigation system in accordance with one or more embodiments of the present disclosure.

FIG. 2 illustrates functional block diagram of a portion of an unmanned aerial vehicle (UAV) in accordance with one or more embodiments of the present disclosure.

FIG. 3 illustrates a block diagram of a portion of the UAV in accordance with one or more embodiments of the present disclosure.

FIG. 4 illustrates a graph of the trajectory of the UAV using a first algorithm in accordance with one or more embodiments of the present disclosure.

FIG. 5 illustrates a graph of the trajectory of the UAV using a second algorithm in accordance with one or more embodiments of the present disclosure.

FIG. 6 illustrates several graphs comparing the UAV performance when operating using the first and the second algorithms in accordance with one or more embodiments of the present disclosure.

FIG. 7 illustrates a table comparing the performance of the first and the second algorithm in accordance with one or more embodiments of the present disclosure.

FIG. 8 is a flow chart for a process of mitigating air pollution in accordance with one or more embodiments of the present disclosure.

FIG. 9 is a flow chart for a process of mitigating air pollution in accordance with one or more embodiments of the present disclosure.

### DETAILED DESCRIPTION

This disclosure relates generally to mitigating air pollution. More specifically, embodiments of the present disclosure relate to use of an unmanned aerial vehicle (UAV) to mitigate air pollution within a geographic area.

Embodiments of the present disclosure provide autonomous UAV-based filtration methods and systems that can detect and mitigate outdoor air pollution within a geographic area. The UAV may get information about a geographic area that requires air pollution mitigation. The UAV may then autonomously transport itself to the geographic area and start an air filtration process. Upon completion of the air filtration process, the UAV may return to its base or starting location.

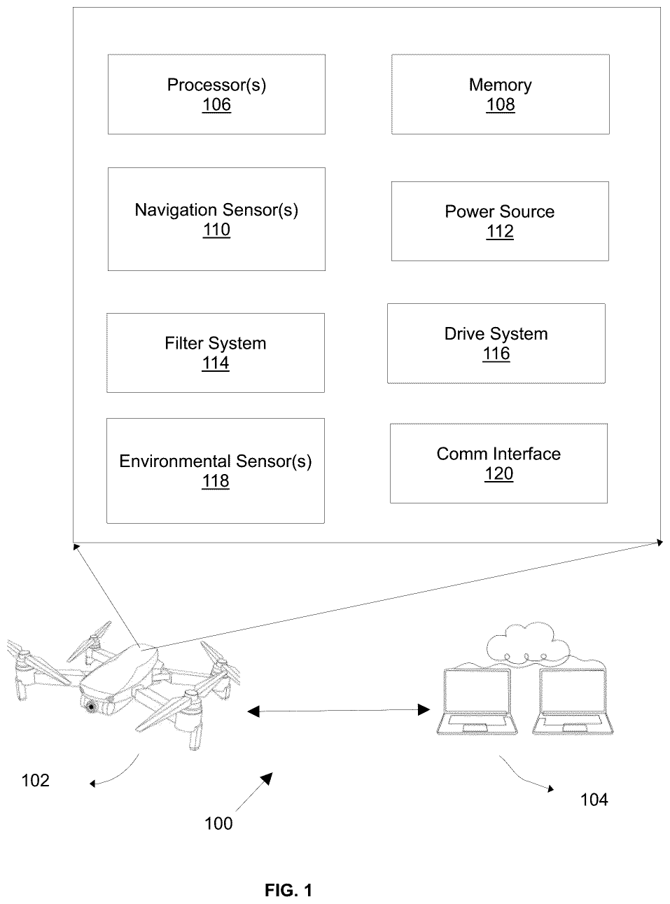

FIG. 1 illustrates a system 100 that can be used for air pollution mitigation in accordance with one or more embodiments of the present disclosure. System 100 includes a UAV 102 and one more servers 104. Server(s) 104 may be remote cloud-based servers that can control and monitor the operation of the UAV 102. UAV 102 is communicably coupled to the server 104 via any known wireless communication method.

UAV 102 can include one or more processors 106, one more memories 108, one or more navigation sensors 110, one or more power sources 112, a filter system 114, a drive system 116, one or more environmental sensors 118, and a communication interface 120.

The one or more processors 106 may control the operation of the UAV 102. For example, the one or more processors 106 may communicate with the server 104 to receive instructions regarding performing a filtration process at a specific geographic area. The one or more processors 106 are communicably coupled to the one or more memories 108. The one or more memories 108 store instructions, which when executed by the one or more processors 106 control the operation of the UAV 102. The one more more memories 108 may store instructions that may monitor the filtration process in real-time and provide real-time data to the server 104. The server 104 may send instructions in real-time to the UAV 104 in order to manipulate the operation of the UAV 104.

UAV 104 may further include one or more navigation sensors 110 that help the UAV 104 with navigation. The navigation sensors 110 may include one or more of: accelerometers, gyroscopes, cameras, global positioning sensors, optical sensors, acoustic sensors, ultrasonic sensors, magnetometer, barometer, and the like. One skilled in the art will realize that UAV 104 may include other navigation sensors not mentioned herein. All of such navigation sensors are within the scope of this disclosure. The navigation sensors 110 may provide real-time data to the one or more processors, which in turn may control the drive system 116 in order to control the motion of the UAV 104.

The UAV 104 may also include a power source 112. The power source 112 may be one or more batteries, such as lithium-ion, Nickel Cadmium (NiCad), Lithium polymer (LiPo), or the like. One skilled in the art will realize that other types of power source may also be present. The UAV may include one or more filter systems 114. Filter system 114 may include either a passive filter or an active filter. A passive filter can be such that a membrane traps pollutants from ambient air and thereby helps to clean the ambient air. Filter system 114 may include one or more of: HEPA filters, UV light filters, electrostatic filters, washable filters, media filters, spun glass filters, pleated filters, or the like. In an embodiment, filter system 114 may include a fibbonnacci spiral filter that will be explained in detail below. Filter system 114 may help with trapping the pollutant particulates in the ambient air thereby helping to clean the ambient air.

The UAV 104 may also include a drive system 116 that helps with actuating and controlling the motion of the UAV 104. The drive system 116 may include a motor, one or more propellers, etc. The drive system 116 takes inputs from the one or more processors 106 and operates accordingly to control the direction, speed, trajectory, etc. of the UAV 104.

The UAV 104 may also include one or more environmental sensors 118. The environmental sensors may include air quality sensors that measure the particulate matter (PM) in the ambient air. In an embodiment, a particulate matter sensor PM 2.5 may be used. In other embodiments, other known sensors such as PM 10, laser particle sensor, light emitting diode (LED) particle sensor, or the like may also be used. The choice of a particulate matter sensor may depend on the nature and extent of pollutants in the ambient air.

The UAV 104 may also include a communication interface 120. The communication interface may be any known wireless interface such as Wi-Fi, Bluetooth, personal area network, or the like. The communication interface 120 receives data from the server 104 regarding the operation or task associated with the UAV 104. For example, the communication interface may receive a set of geographic coordinates from the server 104 where an air filtration operation is to be performed. The communication interface 120 may relay this data to the one or more processors 106, which in turn may work with the navigation sensors 110, the drive system 116, and the one or more memories 108 to navigate the UAV 104 to those geographic coordinates.

While the UAV 104 is described above as having specific components, one skilled in the art will realize that the UAV 104 may include more or less components than described above. Further, this disclosure uses the UAV 104 to explain the various embodiments, however, it is to be noted that other similar air, water, and ground-based vehicles may also be used to perform the air filtration processes described herein. The embodiments of this disclosure are not limited to UAVs.

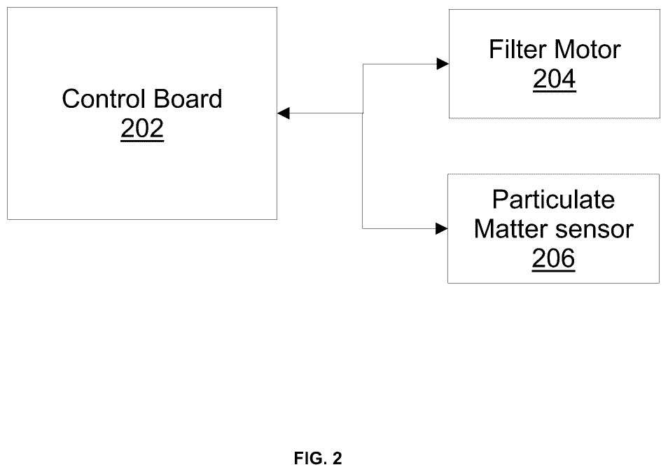

FIG. 2 illustrates a block diagram of a portion of the UAV 102 in accordance with one or more embodiments of the present disclosure. UAV 102 includes a control board 202 that may act as the main logic board that houses the one or more processors 106 and the memory 108. The control board 202 is communicably coupled to filter motor 204 and a particulate matter sensor 206. The control board 202 may receive data collected by the particulate matter sensor 206 and use that data to operate the filter motor 204. The filter motor 204 may operate an associated air draw device, such as a Fibonacci spiral, in order to draw-in the ambient air and trap the pollutants in the ambient air before releasing the cleaned ambient air back to the environment.

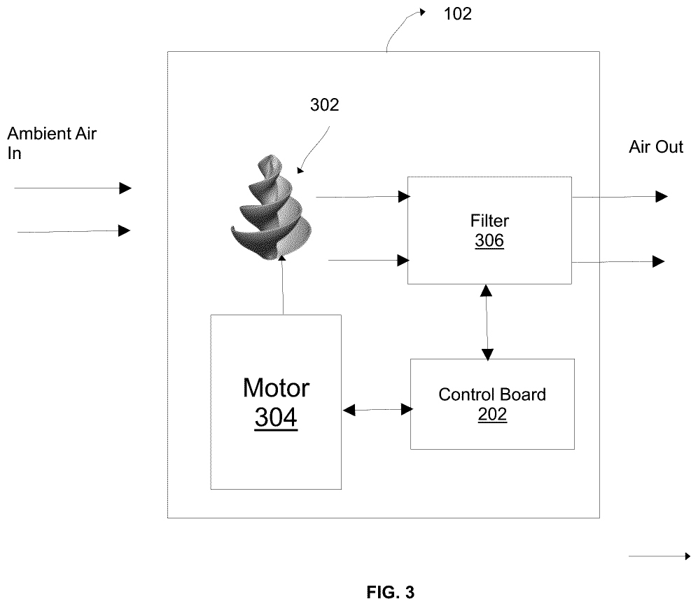

FIG. 3 illustrates a filter system 300 in accordance with one or more embodiments of the present disclosure. The filter system 300 includes a Fibonacci spiral 302, a filter motor 304 coupled to the Fibonacci spiral 302, and a particulate matter filter 306 in fluid communication with the Fibonacci spiral 302. In operation, the control board 202 may operate the filter motor 304 to rotate the Fibonacci spiral 302 at a specified speed (e.g., measured in revolutions per minute (RPM)). The Fibonacci spiral 302 draws in the ambient air and directs it towards the particulate matter filter 306. The particulate matter filter 306 traps the pollutants in the ambient air and cleaner ambient air leaves the particulate matter filter 306. The control board 202 may also continually monitor the filter 306 to determine its efficiency. For example, for a period of operation, the filter 306 may become clogged thereby reducing its efficiency for trapping pollutant particle matter. In one embodiment, the filter 306 or associated circuitry may send a message to the control board 202 indicating that the filter 306 is no longer effective and needs replacement. The control board 202 may then send an indication to the server 104 indicating that the filter 306 may need to be replaced. The indication may be in the form of an audio, visual, or any other similar output.

In an embodiment, before a pollution mitigation operation can be performed, it may be necessary to first determine the source and the location of the pollution. In one embodiment, a gradient ascent algorithm may be used to determine the source and the location of the pollution. For example, assume that there is one source of the pollution and the ambient air is not turbulent. In this instance, the pollutant field can be assumed to follow a plume model and the pollutant concentration can be measured as below.

$$C = \frac{Q}{2 {πσ}_{y} {σ}_{z}} {e}^{\frac{- {( y - {y}_{0} )}^{2}}{2 {σ}_{y}^{2}}} ( {e}^{\frac{- {( z - {z}_{0} - H )}^{2}}{( 2 {σ}_{z}^{2} )}} + {e}^{\frac{- {( z - {z}_{0} - H )}^{2}}{( 2 {σ}_{z}^{2} )}} ) \qquad ( 1 )$$

C=Pollutant Concentration
Q=source emission rate (g/s)
u=wind speed (m/s)
y=cross-wind distance from stack of the source of pollution (m)
z=vertical height of the point of interest (m)
H=effective stack height (m)
x=x coordinate of point of interest (m)
σ_{y}=horizontal stability parameter (m)
σ_{z}=vertical stability parameter (m)

$$Source - of - pollution : ( {x}_{0} , {y}_{0} , {z}_{0} ) \\ {a}_{y} = 0.5 ; {b}_{y} = 0.92 ; \\ {σ}_{y} = {a}_{y} * {abs ( x - {x}_{0} )}^{{b}_{y}} ; \\ {a}_{z} = 0.5 ; {b}_{z} = 0.87 ; \\ {σ}_{z} = {a}_{z} * {abs ( x - {x}_{0} )}^{{b}_{z}} ; \qquad ( 2 )$$

In one embodiment, the server 104 executes the gradient ascent algorithm and sends instructions to the UAV 102. In another embodiment, the UAV 102 may execute the gradient ascent algorithm. Initially, the UAV may receive information about a geographic area in which potential pollution may be present. For example, the server 104 may receive data that indicates one or more polluting events, such as a fire, that is either in progress or has occurred in recently. The server 104 may provide information about the geographic area, e.g., GPS coordinates, to the UAV 102. The UAV may then travel to the geographic area based on the information. Once at the geographic area, the UAV 102 starts taking pollution measurement using one or more of the environmental sensor. A first location at which the particulate measurement exceeds a predetermined threshold is designated as the “starting point” by the UAV 102. In one instance, the UAV 102 designated the starting point as being x₀,y₀,z₀ with coordinates of (0,0,0).

Thereafter the UAV 102 and moves a prescribed distance in the x-direction (x₁) from the starting point and takes a first particulate measurement. The UAV 102 then returns to the starting point and moves by the prescribed distance in the y-direction (y₁) from the starting point and take a second particulate measurement. The UAV 102 then returns to the starting point and moves by the prescribed distance in the z direction (z₁) and takes a third particulate measurement. In one embodiment, the particulate matter measurements may have a value on a scale of 0-100. The first, the second and the third particulate measurements are then added together and the sum of the particulate measurements is used as a denominator in determining ratios or weighted average for each of the first, the second and the third particulate measurements. For instance, consider that the first particulate measurement is 50, the second particulate measurement is 100, and the third particulate measurement is 75. The combined particulate measurement is 225. The weighted average for first particulate measurement will be 50/125, which is 0.22. Similarly the weighted average for the second particulate measurement will be 0.44 and the weighted average for the third particulate measurement will be 0.33. Based on these values, the UAV 102 may determine that the source of the pollution is likely along the y-z direction, weighted more towards the y-direction. The UAV 102 may then determine a second location based on the above information and move to the second location. Let's assume that this location is x₁, y₁, z₁ with coordinates of (0, 5, 2). The UAV then travels to the second location and the second location now becomes the new “starting location” and the above process is repeated again.

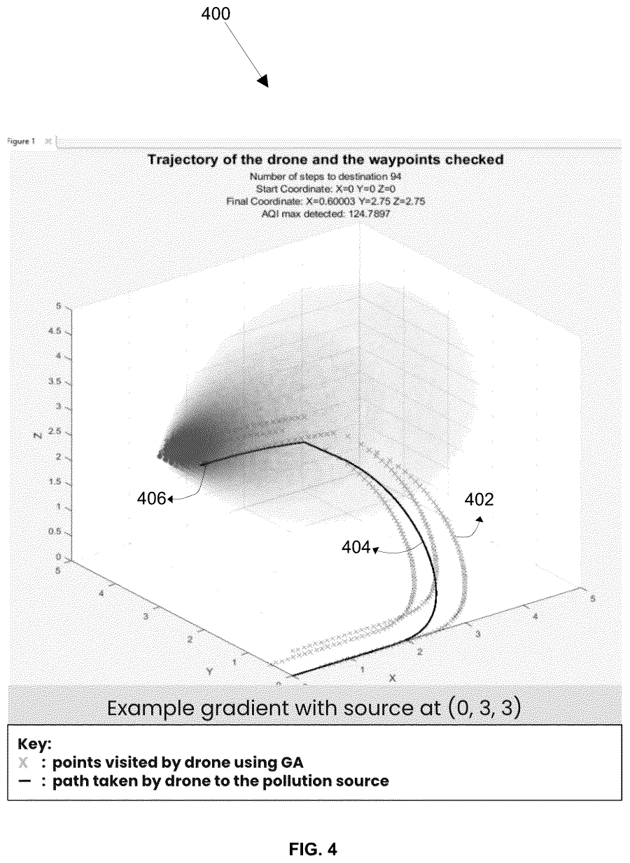

The above-mentioned iterative process is performed by the UAV 102 until at least one particulate matter measurement in all of the x, y, and z directions at a current location is lower than a particulate matter at a location immediately preceding that current location. Once that is determined, the location immediately preceding the current location is designated as having the highest pollution concentration. In this instance, the system can conclude that the UAV 102 has reached the location that has the highest pollutant concentration. The UAV can then initiate the filtering process starting at this location. FIG. 4 illustrates a graph 400 that shows the travel path of the UAV 102 in order to determine the highest pollutant concentration location using the gradient ascent algorithm. Points 402 marked as ‘x’ represent the various points at which the UAV 102 takes particulate matter measurements. The solid black like 404 represents the path taken by the UAV 102 to reach the source location of the pollution 406.

In another embodiment, a gradient ascent particle filtration algorithm may be used to determine the source and location of the pollution/particulate matter. For example, the gradient ascent particle filtration algorithm uses a state estimation machine learning filter and the environmental sensor readings to estimate the source and location of the pollution. In the gradient ascent particle filtration algorithm, the UAV may receive information about a geographic area where potential pollution may be present. The UAV 102 may travel to the geographic area and start taking particulate matter measurements at a starting point (e.g., x₀,y₀,z₀) within the geographical area. The UAV navigates in x, y, and z directions from this starting point and at each point in its travel path, it takes particulate matter measurements, such as by using the environment sensors 112. At each point along its travel path, the UAV 102 compares the particulate matter measurement with a predetermined threshold. If the particulate matter measurement at the current location is higher than the threshold, the UAV 102 travels further along that direction until it determines that the particulate matter reading at a location is below the threshold. This process is repeated for all the x, y, and z directions. The UAV 102 thus determines a bounding box associated with the area of potential pollution. The bounding box can be of cuboid-shape that represents the area of potential pollution. In other embodiments, the bounding box may be of any other shape based on the particulate matter measurements.

One the bounding box associated with the area of potential pollution is determined, the UAV may then select a set of locations within the bounding box as being potential sources of the pollution. These set of locations may be chosen randomly or they can be based on the particulate matter readings that the UAV 102 has gathered during its travel to determine a bounding box. Thereafter the UAV 102 may pick one of the locations within the set of locations as its starting point and perform a number of iterations. For a given area, the Gaussian plume model describes the three-dimensional concentration field generated by a point source under stationary meteorological and emission conditions.

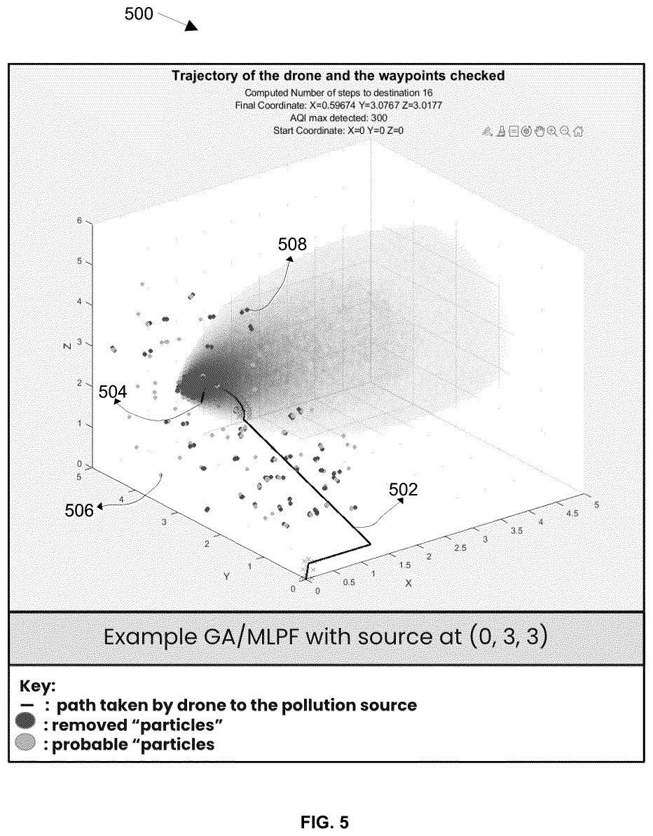

During each iteration, the UAV 102 may determine the current location of the UAV 102. The UAV 102 then provides its current location information and a first location of the set of locations mentioned above, as inputs to a custom function. The custom function utilizes the Gaussian field estimation equation (1) described above and outputs an estimated air quality index (AQI) value. The estimated AQI value is compared against an actual AQI value for the current location. The actual AQI value for the current location may be determined using one or more of the environmental sensors of the UAV 102. If the absolute difference between the estimated AQI value and the actual AQI value at the current location is less than 2, the first location is designated as not being the source of pollution and removed from the set of locations. If not, the first location is retained in the set of locations. The UAV 102 may then move to a new location within the bounding box. The above process is repeated again at the new location to either retain or remove a second location from the set of locations as being a potential location for the source of the pollution. This process is repeated continually where new locations from the set of locations and a current location of the UAV are provided as inputs to the custom function and based on the comparison between the estimated AQI value to the actual AQI value, these new locations are either removed from or retained in the set of locations. Once the number of remaining locations within the set of locations reaches below a threshold value, e.g., 200, (e.g., by the process of elimination or retention described above) a median location of the remaining locations in the set of locations is determined and the UAV 102 is directed to move to that median location. The median location can then be designated as the “starting location” for executing the gradient ascent algorithm described above. Thereafter, the UAV 102 may utilize the gradient ascent algorithm explained in relation to FIG. 4 above and proceed to locate the source of the solution. FIG. 5 illustrates a graph 500 that shows the trajectory of the UAV 102 using the gradient ascent particle filtration algorithm. The solid black line 502 represents a path taken by the UAV to locate the source of the pollution 504. Points 506 represent the set of locations that are initially selected as potential sources of the pollution. The points 508 represent the locations that are removed from the set of locations as being not the probable sources of pollution.

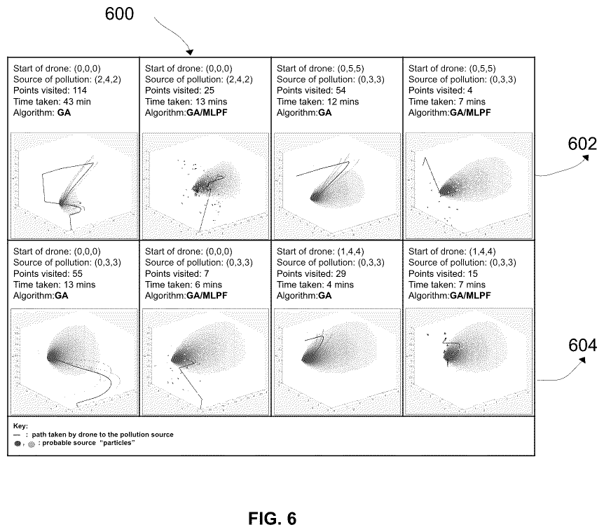

FIG. 6 illustrates a collection of graphs 600 that show the relative

performance of the gradient ascent particle filtration algorithm and the gradient ascent algorithm in accordance with one or more embodiments of the present disclosure. In FIG. 6 “GA” is indicative of the gradient ascent algorithm and “GA/MLPF” is representative of the gradient ascent particle filtration algorithm. FIG. 6 shows the results 602 in which the pollution source point location was varied (e.g., (2,4,2) and (0,3,3,)) while keeping the starting point of the UAV constant (e.g., 0,0,0). As can be seen the gradient ascent particle filtration algorithm results in the UAV taking a shorter path and less time to reach the source of the pollution. FIG. 6 also shows graphs 604 in which the UAV start position was varied and the location of the source of the pollution was kept constant. As can be seen from the graphs 604, the gradient ascent particle filtration algorithm results in an optimized and shorter trajectory of travel for the UAV and also results in less time for the UAV to locate the source of the pollution compared to the gradient ascent algorithm. It is to be noted that both the gradient ascent algorithm and the gradient ascent particle filtration algorithm are effective in finding the source of the pollution. The decision on which algorithm to use may depend on the potential area of the pollution, computational and other capabilities of the UAV, severity of the pollution, etc. Both the above algorithms are viable and usable in practical applications.

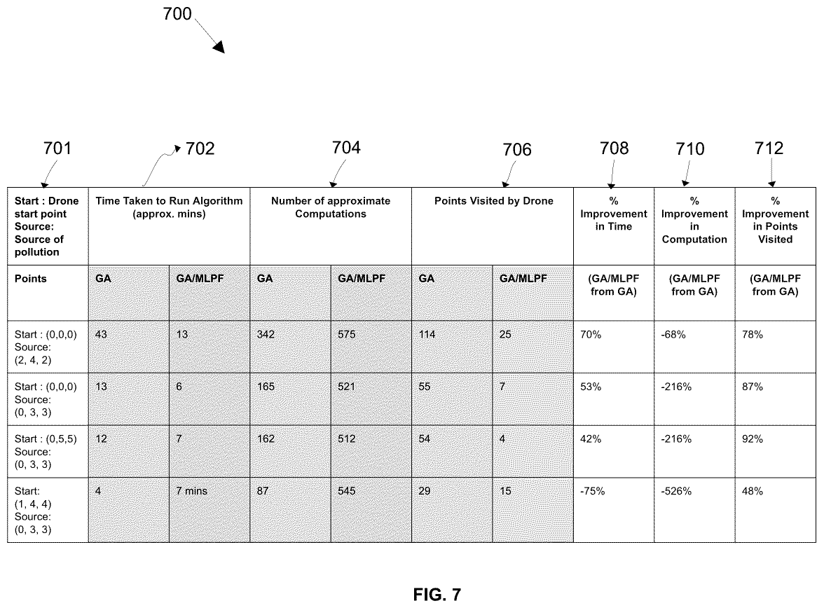

FIG. 7 includes a table 700 that illustrates the relative performance of the gradient ascent and the gradient ascent particle filtration algorithm according to an embodiment of the present disclosure. Column 702 shows the time taken for the gradient ascent algorithm and the gradient ascent particle filtration algorithms to run for the various scenarios shown in column 701 for finding the source of the pollution. Column 704 shows the number of approximate computations needed for each of the gradient ascent algorithm and the gradient ascent particle filtration algorithms to determine the source of the pollution. Column 706 shows the number of locations visited by the UAV for each of the the gradient ascent algorithm and the gradient ascent particle filtration algorithms to determine the source of the pollution. Column 708 shows the approximate improvement in time between the gradient ascent algorithm and the gradient ascent particle filtration algorithms to determine the location of the source of the pollution. Column 710 shows the approximate improvement in computations between the gradient ascent algorithm and the gradient ascent particle filtration algorithms to determine the location of the source of the pollution. Column 712 shows the improvement in the number of locations visited by the UAV when using the gradient ascent algorithm and the gradient ascent particle filtration algorithms to determine the location of the source of the pollution. As can be seen from the table 700, the gradient ascent particle filtration algorithm offers benefits in terms of time taken to run the algorithms and the number of locations visited by the UAV. The gradient ascent algorithm fares better in terms of number of computations needed be the UAV. Thus, it can be seen that the choice of using either the gradient ascent algorithm or the gradient ascent particle filtration may depend on the hardware and computational capabilities of the UAV, the extent of the area of pollution, the severity of the pollution, and other factors. Both the algorithms can be used in a real-world scenario.

For example, as shown in FIG. 7, when the pollution source location was varied, the gradient ascent particle filtration algorithm resulted in significantly shorter time for the UAV 102 to complete its determination of the location having the highest pollutant concentration. In one instance, the use of the gradient ascent particle filtration algorithm resulted in approximately 70% reduction in the time for the UAV 102 to complete its determination of the location having the highest pollutant concentration compared to when the gradient ascent algorithm was used. In addition, the gradient ascent filtration algorithm results in far fewer locations that the UAV 102 needs to take pollution measurements as part of determining the location having the highest pollutant concentration. In one instance, the reduction in the number of locations that the UAV 102 visited to take the particulate matter measurements were 80-90% lower when executing the gradient ascent particle filtration algorithm compared to just using the gradient ascent algorithm.

A good starting location for the UAV 102 to start taking the particulate matter measurement can help to reduce the amount of measurements taken, or number of locations at which the measurements need to be taken, or both. However, it is not easy to find this optimal starting location. An incorrect starting location may result in the UAV 102 taking longer to determine the location having the highest pollutant concentration. It can difficult to estimate the exact location of this “starting point” from which the UAV 102 can start taking the particulate matter readings in order to determine the location having the highest pollutant concentration. In some instances, the UAV 102 power source may fall below a threshold where the UAV 102 may need to return to its starting location for replacing and/or recharging the power source. In order to avoid the UAV 102 from failing to accomplish its task, it is helpful if the starting location for taking the particulate matter measurements is as close as possible to the actual location having the highest pollution concentration. In this scenario, the gradient ascent particle filtration algorithm results in about 42% decrease in the time it takes for the UAV 102 to determine the location having the highest pollution concentration compared to using just the gradient ascent algorithm. In other words, the gradient ascent filtration algorithm is able to determine the starting location for taking the particulate measurements that is much closer to the location having the highest pollution concentration than when using just the gradient ascent algorithm. In terms of the number of locations at which the UAV 102 may need to take particulate matter measurements is reduced by about 90% when compared to using just the gradient ascent algorithm. Moreover, the trajectory of the UAV 102 when using the gradient ascent filtration algorithm is much smoother and optimized than when using the gradient ascent algorithm, as illustrated in FIG. 6.

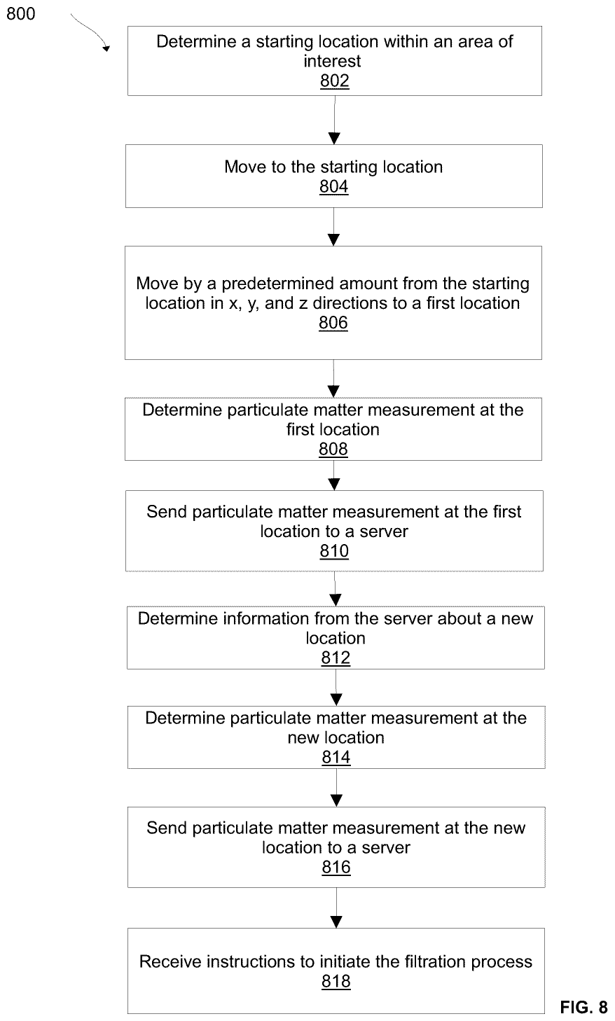

FIG. 8 illustrates a flow chart for a process 800 according to an embodiment of the present disclosure. Process 800 may be performed, for example, by the UAV 102. At step 802, the UAV determines a starting location associated with an area of interest. For example, the area of interest may be a geographical region in which there may be a need to mitigate pollution. The starting location may be location from where the UAV starts taking particulate matter measurements. The UAV may then travel to the starting location within the area of interest at step 804. At step 806, the UAV may move by a predetermined distance in the x, y, and x directions from the starting location. After each movement in each of these directions, the UAV may take particulate matter measurements (step 808). These particulate matter measurements are then optionally sent back to the server, e.g., server 104, at step 810 or the UAV may retain these particulate matter measurements in its memory. The server or the UAV may then determine a second location (step 812) based on the particulate measurement data as described above in relation to FIG. 4. The UAV may then travel to the second location and take second particulate matter measurements at the second location at step 814. The particulate matter measurements at the second location are then optionally sent back to the server at step 816 or retained by the UAV. Based on the particulate matter measurements at the second location, the server or the UAV may compute a new (e.g., a third location). This iterative process may continue for a few cycles until the server or the UAV determines that the UAV 102 is at a location with the highest pollution concentration, for example, as described above in relation to FIG. 4. Thereafter, the UAV 102 may receive instructions to initiate the filtration process at step 818 or may autonomously start the filtration process.

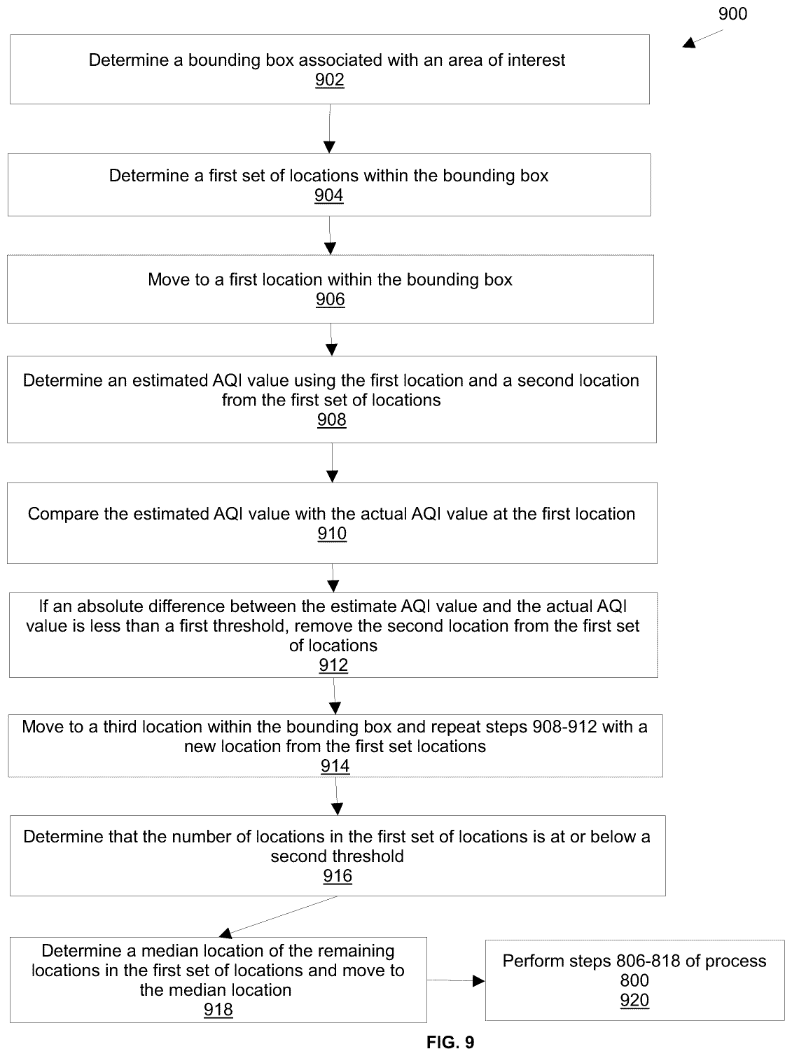

FIG. 9 is a flow chart for a process 900 according to an embodiment of the present disclosure. Process 900 may be performed, e.g., by the UAV 102 of FIG. 1. At step 902, the UAV may determine a bounding box associated with the are of interest. The area of interest may the geographic area where pollution is detected. The bounding box may be indicative of the overall area affected by the pollution that may be need to be mitigated. At step 904, the UAV may determined a first set of locations within the bounding box. At step 906, the UAV moves to a first location within the bounding box. In an embodiment, the first location may be part of the first set of locations, but that is not needed. The first location may be any location within the bounding box. At the first location, the UAV determines an estimated AQI value, e.g., using the custom function and second location from the first set of locations as described above in relation to FIG. 5, at step 908. At step 910, the estimated AQI value is compared to an actual AQI value at the first location. If the absolute difference between the estimated AQI value and the actual AQI value is less or equal to a first threshold value, the second location is removed from the first set of locations, at step 912. The UAV may then move to a third location within the bounding box at step 914 and repeat steps 908-912 several times to remove additional locations from the first set of locations. At step 916, the UAV may determine that the number of location remaining in the first set of location is less than a second threshold. Thereafter, the UAV may determined a median location using the remaining number of locations in the first set of locations at step 918. Thereafter at step 920, the UAV may perform steps 806-818 of process 800 above to determine the location of the source of pollution or the location having the highest concentration of pollutant matter.

It should be apparent that the foregoing relates only to certain embodiments of the present disclosure and that numerous changes and modifications may be made herein by one of ordinary skill in the art without departing from the general spirit and scope of the disclosure.

Although specific embodiments of the disclosure have been described, numerous other modifications and alternative embodiments are within the scope of the disclosure. For example, any of the functionality described with respect to a particular device or component may be performed by another device or component. Further, while specific device characteristics have been described, embodiments of the disclosure may relate to numerous other device characteristics. Further, although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments.

That which is claimed is:

1. An unmanned aerial vehicle (UAV) comprising:
one or more processors;
a memory coupled to the one or more processors; and
a filter unit coupled to the one more processors, wherein the one or more processors are configured to:
determine information about a first location;
travel to the first location;
move to a second location that is at a predetermined distance from the first location;
determine first particulate matter measurement at the second location;
determine, based on the first particulate matter measurement and the first location, information about a third location;
determine second particulate matter measurement at the third location; and
initiate, based on the second particulate matter measurement and the first particulate matter measurement, a filtration process.

2. The UAV of claim 1, wherein the filter unit further comprises a motor coupled to a fibonacci spiral and a particulate matter filter.

3. The UAV of claim 2, wherein the motor operates the fibonacci spiral to draw in ambient air and direct the ambient air towards the particulate matter filter.

4. The UAV of claim 2, wherein the particulate matter filter includes a PM 2.5 filter.

5. The UAV of claim 1, wherein the second particulate matter measurement is lower than the first particulate matter measurement.

6. The UAV of claim 5, wherein the one or more processor causes the UAV to initiate the filtration process at the second location.

7. The UAV of claim 1, wherein prior to determining the information about the first location, the one more processors are configured to receive information about an area of interest, the area of interest corresponding to a geographical area in which pollution is present.

8. A method comprising:
determining a first location within an area of interest;
traveling to the first location;
moving to a second location, the second location being a predetermined distance from the first location in x, y, or z directions;
determining a first particulate matter measurement at the second location;
determining, based on the first particulate matter measurement and the first location, information about a third location within the area of interest;
moving to the third location;
determining a second particulate matter measurement at the third location; and
initiating, based on the first particulate matter measurement and the second particulate matter measurement, a filtration process.

9. The method of claim 8, wherein initiating the filtration process further comprising initiating the filtration process at the second location.

10. The method of claim 9, wherein the first particulate matter measurement is higher than the second particulate matter measurement.

11. The method of claim 8, further comprising, prior to initiating the filtration process:
determining a fourth location within the area of interest;
determining a third particulate measurement at the fourth location; and
initiating the filtration process further based on the third particulate measurement.

12. The method of claim 8, wherein prior to initiating the filtration process, the method further comprising:
moving back to the second location;
operating a motor coupled to a fibonnaci spiral to draw in ambient air; and
directing the ambient air over a particulate filter.

13. The method of claim 8, wherein the second location is a first predetermined distance from the first location in the x-direction, the method further comprising, prior to moving to the third location:
moving to a fourth location that is the first predetermined distance from the first location in the y-direction;
determining a third particulate measurement at the fourth location;
moving back to the first location;
moving to a fifth location that is the first predetermined distance from the first location in the z-direction;
determining a fourth particulate measurement at the fifth location; and
wherein determining the third location is further based on the third particulate measurement and the fourth particulate measurement.

14. A method comprising, by an unmanned aerial vehicle (UAV):
(i) determining, a bounding box associated with an area of interest;
(ii) determining a first set of locations within the bounding box;
(iii) determining a first location within the bounding box;
(iv) moving to the first location;
(v) determining a first estimated air quality value based on the first location and a second location from the first set of locations;
(vi) determining a first actual air quality value at the first location;
(vii) determining that an absolute difference between the first estimated air quality value and the first actual air quality value is less than or equal to a first threshold value;
(ix) removing the second location from the first set of locations;
(x) determining a third location within the bounding box;
(xi) moving to the third location; and
(xii) performing steps (v)-(ix) at the third location.

15. The method of claim 14, further comprising:
determining that a number of locations in the first set of locations is less than a second threshold;
determining a median location of the number of locations; and
moving to the median location.

16. The method of claim 15, further comprising:
moving to a fourth location, wherein the fourth location is at a predetermined distance from the median location in x, y, or z directions; and
determining a first particulate matter measurement at the fourth location.

17. The method of claim 15, further comprising:
moving to a fourth location, wherein the fourth location is at a first predetermined distance from the median location;
determining a first particulate matter measurement at the fourth location;
moving to a fifth location, wherein the fifth location is at a second predetermined distance from the median location;
determining a second particulate matter measurement at the fifth location; and
determining that the first particulate matter measurement is higher than the second particulate matter measurement.

18. The method of claim 17, further comprising initiating a filtration process at the fourth location.

19. The method of claim 14, wherein determining the first estimated air quality value includes using a Gaussian field estimation function.

20. The method of claim 14, further comprising:
determining a second estimated air quality value using the third location and a fourth location from the first set of locations;
determining a second actual air quality value at the third location;
determining that the absolute difference between the second estimated air quality value and the second actual air quality value is more than the first threshold value; and
retaining the third location in the first set of locations.
